(19) United States
(12) Patent Application Publication
(10) Pub. No.: US 2019/0312277 A1
(43) Pub. Date: Oct. 10, 2019

(54) THREE-DIMENSIONAL STRUCTURED PLANT-FIBER CARBON MATERIAL FOR USE AS ANODE MATERIAL FOR SODIUM-ION BATTERY AND LITHIUM-ION BATTERY, AND PREPARATION METHOD THEREOF

(71) Applicant: SOUTH CHINA UNIVERSITY OF TECHNOLOGY, Guangdong (CN)

(72) Inventors: Chenghao YANG, Guangdong (CN); Jiawen XIONG, Guangdong (CN); Xunhui XIONG, Guangdong (CN)

(73) Assignee: SOUTH CHINA UNIVERSITY OF TECHNOLOGY, Guangdong (CN)

(21) Appl. No.: 16/315,149

(22) PCT Filed: Nov. 27, 2017
(86) PCT No.: PCT/CN2017/113058

§ 371 Date: Jan. 3, 2019

(30) Foreign Application Priority Data
Jan. 4, 2017 (CN) 201610963618.7

(51) Int. Cl. H01M 4/583; H01M 10/0525; H01M 10/054

(52) U.S. Cl. CPC H01M 4/583; H01M 2004/027; H01M 10/054; H01M 10/0525

(57) ABSTRACT

The present invention provides a three-dimensional structured plant-fiber carbon material for use as an anode material for a sodium-ion battery and a lithium-ion battery, and a preparation method thereof. The preparation method of the three-dimensional structured plant-fiber carbon material comprises: soaking the plant fiber into a pore forming agent, a nitrate solution, wetting the fiber at a constant temperature, after drying, calcining and grinding the fiber at a protective atmosphere, washing the resulted material with hydrochloric acid and deionized water and drying the material. The three-dimensional structured plant-fiber carbon material has a three-dimensional porous thin sheet-like and long tunnel structure, wherein the thin sheet has a thickness of 5 to 30 nm. The three-dimensional structured plant-fiber carbon material constructs an excellent conductive network, which, in combination with the porous and long tunnel structure, facilitates rapid diffusion of ions of the electrode material, and improves utilization rate of the material.

### BACKGROUND OF THE INVENTION

### 1. Technical Field

The present invention relates to the technical field of carbonized plant fiber materials, and in particular, relates to a three-dimensional structured plant-fiber carbon material and a preparation method thereof.

### 2. Background

Carbon materials are indispensable in people's daily life, and are very important starting materials in the industrial production of commercial lithium-ion batteries. The carbon material has the advantages such as abundant pore structures, greater specific surface, excellent conductivity, stable chemical properties and is one of the functional materials that are extensively applied.

However, with the wide applications of the lithium-ion batteries, lithium resources are being exhausted. To relief resource restrictions, development and application of sodium-ion batteries are increasing. Sodium-ions have the advantages such as rich starting materials, high specific capacity and efficiency, low cost and the like, and are expected to be widely applied in large-scale energy storage and intelligent power grids. Since sodium and lithium belong to the same family and have similar physical and chemical properties, the sodium-ion batteries and the lithium-ion batteries have substantially the same charge-discharge principles. During charging, the sodium ions are de-intercalated from cathode materials and intercalated into anode materials through an electrolyte; and during discharging, the sodium ions are de-intercalated from the anode materials and intercalated into the cathode materials through the electrolyte.

The anode material is one of the critical materials of the sodium-ion battery and the lithium-ion battery. In the present invention, the anode material is prepared by using a three-dimensional structured plant-fiber carbon material as a starting material, wherein the three-dimensional structured plant-fiber carbon material has a microstructure that is a three-dimensional porous thin sheet-like and long tunnel structure. The sheet-like material has a thickness of 5 to 30 nm. The three-dimensional porous carbon material constructs an excellent conductive network, which, in combination with the porous tunnel structure, facilitates rapid diffusion of ions of the electrode material, and improves utilization rate of the electrode material. In this way, the capacity of the electrode material is improved, and the cycle life and rate performance thereof are enhanced. The three-dimensional structured plant-fiber carbon material exhibits high specific capacity, and excellent cycle performance and rate performance. According to the present invention, various commonly seen plant fibers and disposable substances in daily life may be used as the starting materials of the anode materials for the sodium-ion battery and the lithium-ion battery. Such starting materials have abundant origins, for example, disposable bamboo chopsticks and the like which may be repeatedly utilized, so as to improve the utilization rate and achieve the objective of environment protection.

### SUMMARY OF THE INVENTION

The present invention is intended to provide a three-dimensional structured plant-fiber carbon material for use as an anode material for a sodium-ion battery and a lithium-ion battery, and a preparation method thereof. The preparation method according to the present invention has a simple process, and starting materials are abundant and cheap, and environmentally friendly. The three-dimensional structured plant-fiber carbon material synthesized by the preparation method according to the present invention exhibits a high specific capacity, and achieves excellent cycle performance and rate performance.

A three-dimensional structured plant-fiber carbon material for use as an anode material for a sodium-ion battery and a lithium-ion battery has a microstructure that is a three-dimensional porous thin sheet-like and long tunnel structure, wherein the sheet-like material has a thickness of 5 to 30 nm. The three-dimensional structured plant-fiber carbon material is capable of constructing an excellent conductive network, which, in combination with the porous structure, facilitates rapid diffusion of ions of the electrode material, and improves utilization rate of the electrode material. In this way, the capacity of the electrode material is improved, and the cycle life and rate performance thereof are enhanced.

The objective of the present invention is implemented by employing the following technical solutions:

A preparation method of the three-dimensional structured plant-fiber carbon material for use as the anode material for the sodium-ion battery and the lithium-ion battery is provided. The preparation method comprises the following steps:

(1) sealing wetting a plant fiber material into a nitrate solution;

(2) after the sealing wetting, taking out the plant fiber material and drying the material;

(3) calcining the plant fiber material which is dried, under a protective atmosphere in a heat preservation manner;

(4) taking out the plant fiber material which is carbonized, and crushing and grinding the material into powder;

(5) sequentially washing the powder with a hydrochloric acid having a concentration of 0.5 to 3 mol/L and deionized water respectively, and drying the powder to obtain a dried, black powder-like, three-dimensional structured plant-fiber carbon material.

Further, in step (1), the plant fiber material comprises seed fiber series, bast fiber series, leaf fiber series, fruit fiber series or plant waste fiber series, the seed fiber series comprising cotton fibers or kapok fibers, the bast fiber series comprising flax or bamboo fibers, the leaf fiber series comprising sisal, pineapple fibers or abacas, the fruit fiber series comprising coconut fibers or pineapple pulp fibers, and the plant waste fiber series comprising coffee residues or used disposable bamboo chopsticks.

Further, in step (1), the nitrate is at least one of magnesium nitrate, sodium nitrate and potassium nitrate, and the nitrate solution has a concentration of 0.1 to 10 mol/L.

Further, in step (1), the sealing wetting is carried out at a temperature of 60 to 100° C., and the sealing wetting lasts for 4 to 24 hours.

Further, in step (3), the protective atmosphere is an inert atmosphere, a reduction atmosphere or a mixture atmosphere; the inert atmosphere being nitrogen or argon, the reduction atmosphere being hydrogen, and the mixture atmosphere being a mixture of nitrogen and hydrogen or a mixture of argon and hydrogen, wherein a volume ratio of the hydrogen is 0% to 10%.

Further, in step (3), the calcination in the heat preservation manner has a heating rate of 5 to 10° C./min, the calcination in the heat preservation manner is carried out at a temperature of 600 to 900° C., and the calcination in the heat preservation manner lasts for 1 to 6 hours.

Further, in step (2) and step (5), the drying is carried out in an oven at a temperature of 60 to 100° C. for 6 to 24 hours.

The present invention is further intended to provide use of the three-dimensional structured plant-fiber carbon material for use as the anode material for the sodium-ion battery and the lithium-ion battery, wherein the three-dimensional structured plant-fiber carbon material is used for the preparation of a sodium ion secondary battery and a lithium ion secondary battery.

Compared with the prior art, the present invention has the following advantages and achieves the following beneficial effects:

(1) The three-dimensional structured plant-fiber carbon material according to the present invention is an amorphous carbon material. The more the added pore forming agent (nitrate salt), the fewer the bar-shaped fibers, and the more the three-dimensional thin sheet-like carbon. The sheet-like material has a thickness of 5 to 30 nm.

(2) The three-dimensional structured plant-fiber carbon material according to the present invention constructs an excellent conductive network, which, in combination with the porous, long tunnel structure, facilitates rapid diffusion of ions of the electrode material, and improves utilization rate of the electrode material.

(3) The three-dimensional structured plant-fiber carbon material according to the present invention is used as the anode material for the sodium-ion battery and the lithium-ion battery, which exhibits a high specific capacity, and achieves excellent cycle performance and rate performance.

(4) The preparation method according to the present invention is simple to carry out, and sources of the starting materials are abundant and environmentally friendly.

### BRIEF DESCRIPTION OF THE DRAWINGS

FIG. 1 illustrates XRD patterns of three-dimensional structured cotton fiber carbon materials prepared by using pore forming agents, solutions of magnesium nitrate, having concentrations of 0 mol/L, 0.25 mol/L, 0.5 mol/L and 0.75 mol/L respectively according to Embodiment 1;

FIG. 2a illustrates a SEM image of the three-dimensional structured cotton fiber carbon material prepared by using the pore forming agent, the solution of magnesium nitrate, having the concentration of 0 mol/L according to Embodiment 1;

FIG. 2b illustrates a SEM image of the three-dimensional structured cotton fiber carbon material prepared by using the pore forming agent, the solution of magnesium nitrate, having the concentration of 0.25 mol/L according to Embodiment 1;

FIG. 2c illustrates a SEM image of the three-dimensional structured cotton fiber carbon material prepared by using the pore forming agent, the solution of magnesium nitrate, having the concentration of 0.5 mol/L according to Embodiment 1;

FIG. 2d illustrates a SEM image of the three-dimensional structured cotton fiber carbon material prepared by using the pore forming agent, the solution of magnesium nitrate, having the concentration of 0.75 mol/L according to Embodiment 1;

FIG. 2e illustrates a SEM sectional image of the three-dimensional structured cotton fiber carbon material prepared by using the pore forming agent, the solution of magnesium nitrate, having the concentration of 0.75 mol/L according to Embodiment 1;

FIG. 3 illustrates a 50-cycle capacity view of the three-dimensional structured cotton fiber carbon materials prepared by using the pore forming agents, the solutions of magnesium nitrate, having the concentrations of 0 mol/L, 0.25 mol/L, 0.5 mol/L and 0.75 mol/L according to Embodiment 1, as anode materials for sodium-ion batteries, under a current density of 100 mA/g;

FIG. 4 illustrates a 100-cycle capacity view of the three-dimensional structured cotton fiber carbon materials prepared by using the pore forming agents, the solutions of magnesium nitrate, having the concentrations of 0 mol/L, 0.25 mol/L, 0.5 mol/L and 0.75 mol/L according to Embodiment 1, as the anode materials for the sodium-ion batteries, under a current density of 1.0 A/g;

FIG. 5 illustrates rate performance views of the three-dimensional structured cotton fiber carbon materials prepared by using the pore forming agents, the solutions of magnesium nitrate, having the concentrations of 0 mol/L, 0.25 mol/L, 0.5 mol/L and 0.75 mol/L according to Embodiment 1, as the anode materials for the sodium-ion batteries;

FIG. 6 illustrates initial charge-discharge curves of the three-dimensional structured cotton fiber carbon material prepared by using the pore forming agent, the solution of magnesium nitrate, having the concentration of 0.75 mol/L according to Embodiment 1, as an anode material for a lithium-ion battery;

FIG. 7 illustrates a 140-cycle capacity view of the three-dimensional structured cotton fiber carbon material prepared by using the pore forming agent, the solution of magnesium nitrate, having the concentration of 0.75 mol/L according to Embodiment 1, as the anode material for the lithium-ion battery, under a current density of 1.0 A/g;

FIG. 8 illustrates a 200-cycle capacity view of the three-dimensional structured cotton fiber carbon material prepared by using the pore forming agents, the solutions of magnesium nitrate, having the concentration of 0.75 mol/L according to Embodiment 1, as the anode material for the lithium-ion battery, under a current density of 2.0 A/g; and

FIG. 9 illustrates a rate performance view of the three-dimensional structured cotton fiber carbon material prepared by using the pore forming agent, the solution of magnesium nitrate, having the concentration of 0.75 mol/L according to Embodiment 1, as the anode material for the lithium-ion battery.

### DETAILED DESCRIPTION OF THE INVENTION

The embodiments hereinafter facilitate better understanding of the present invention. However, the present invention is not limited to these embodiments.

### Embodiment 1

Preparation of Three-Dimensional Structured Cotton Fiber Carbon Materials:

(1) 20 mL of solutions of magnesium nitrate having concentrations of 0 mol/L, 0.25 mol/L, 0.5 mol/L and 0.75 mol/L were respectively formulated, and 1.5 g of defatted cotton fiber was sufficiently soaked in each of the solutions of magnesium nitrate;

(2) the defatted cotton fiber was sufficiently wetted and sealed and stored in a 60° C. oven for 24 hours and then taken out, and the defatted cotton fiber was placed into a 80° C. oven and dried for 24 hours;

(3) the dried defatted cotton fiber was heated to 800° C. at a heating rate of 8° C./min under a nitrogen atmosphere, and calcinated in a heat preservation manner at 800° C. for 3 hours;

(4) after natural cooling, the fiber was crushed and ground, and black powder-like materials were obtained;

(5) the obtained black powder-like materials were sequentially washed with a hydrochloric acid having a concentration of 3 mol/L and deionized water respectively for three times, then the washed materials were dried in the 60° C. oven for 12 hours, and finally dried, black powder-like, three-dimensional structured cotton fiber carbon materials were obtained.

1. Structure Analysis:

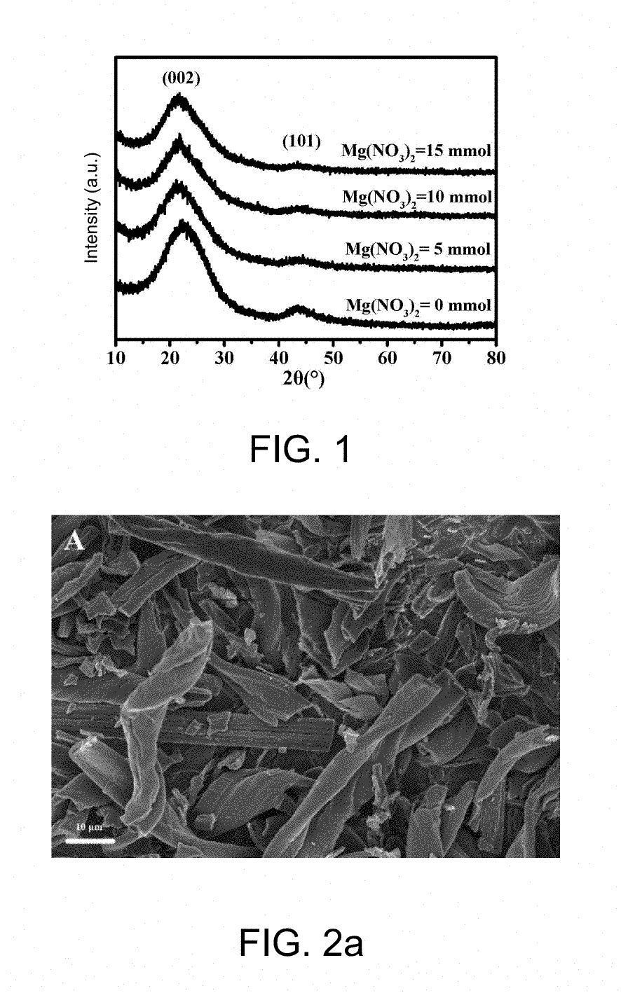

The XRD patterns of the obtained three-dimensional structured cotton fiber carbon materials are as illustrated in FIG. 1. As seen from FIG. 1, the prepared three-dimensional structured cotton fiber carbon materials are all amorphous carbon materials.

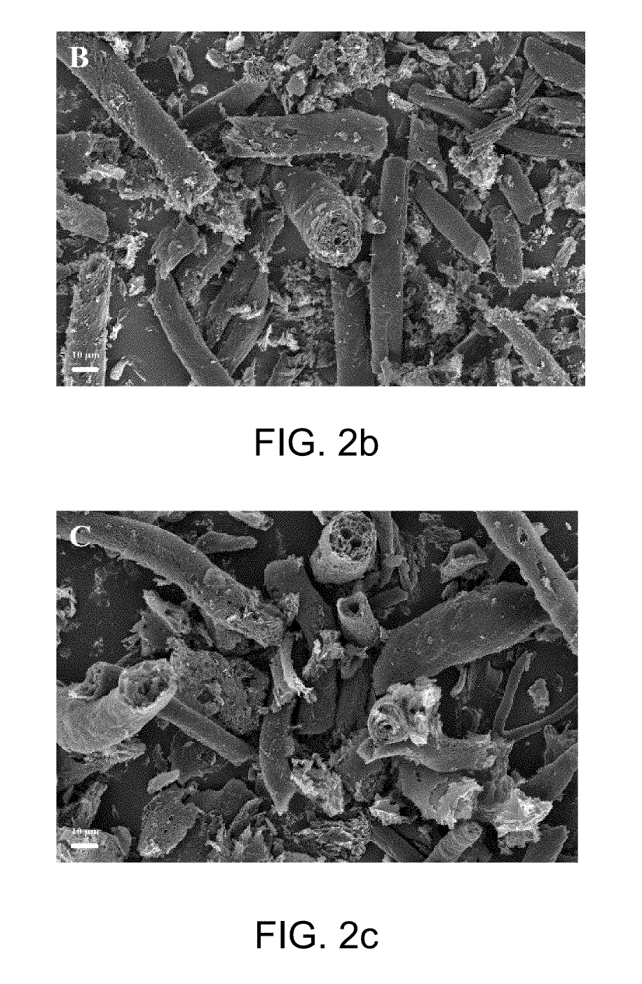

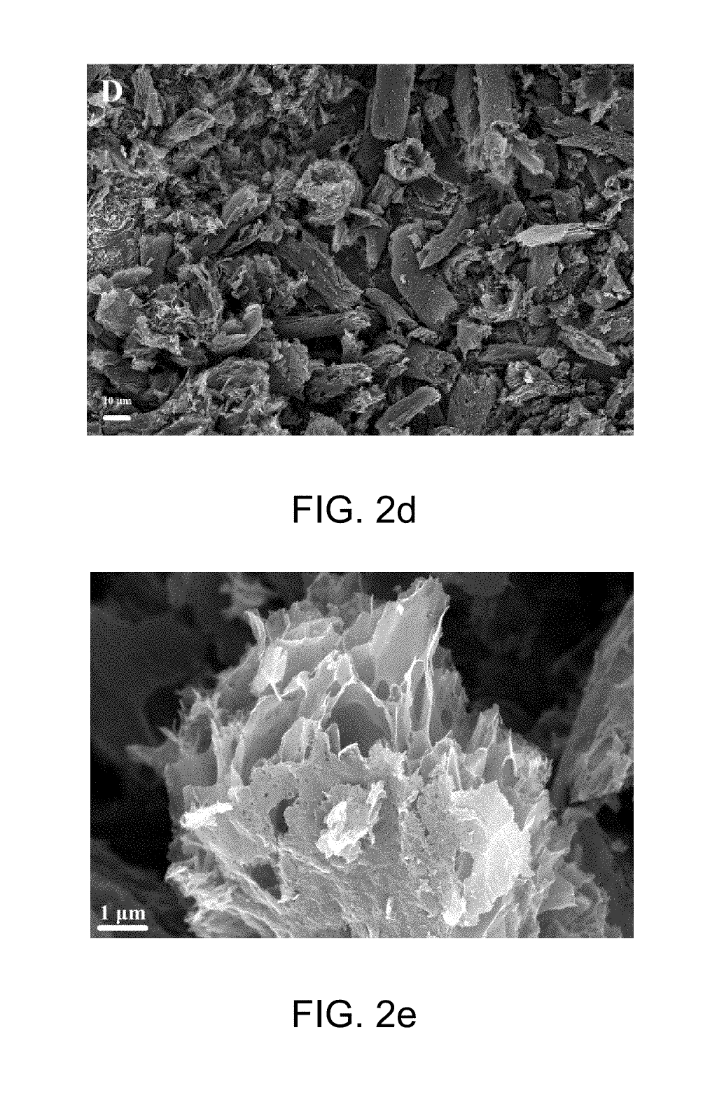

The SEM images of the three-dimensional structured cotton fiber carbon materials prepared by using the pore forming agents, the solutions of magnesium nitrate, having the concentrations of 0 mol/L, 0.25 mol/L, 0.5 mol/L and 0.75 mol/L respectively, are respectively illustrated in FIG. 2a, FIG. 2b, FIG. 2c and FIG. 2d. As seen from FIG. 2a, FIG. 2b, FIG. 2c and FIG. 2d, the more the added pore forming agent (magnesium nitrate), the less the bar-shaped cotton fiber, and the more the three-dimensional porous thin-sheet carbon. FIG. 2e is a SEM sectional image of the three-dimensional structured cotton fiber carbon material prepared by using the pore forming agent, the solution of magnesium nitrate, having the concentration of 0.75 mol/L according to Embodiment 1. As seen from FIG. 2e, the sheet-like material has a thickness of 5 to 30 nm.

2. Test of Electrochemical Properties (Initial Efficiency, Cycle Performance and Rate Performance):

The prepared three-dimensional structured cotton fiber carbon materials are prepared into negative electrode tabs, and CR2032 button-type sodium-ion batteries and CR2032 button-type lithium-ion batteries are obtained via assembling in a glove box. Charge-discharge tests are performed for the prepared batteries within a voltage range of 0.01 V to 3 V at a constant temperature condition of 25° C.

(1) Electrochemical Properties of the Prepared Sodium-Ion Batteries

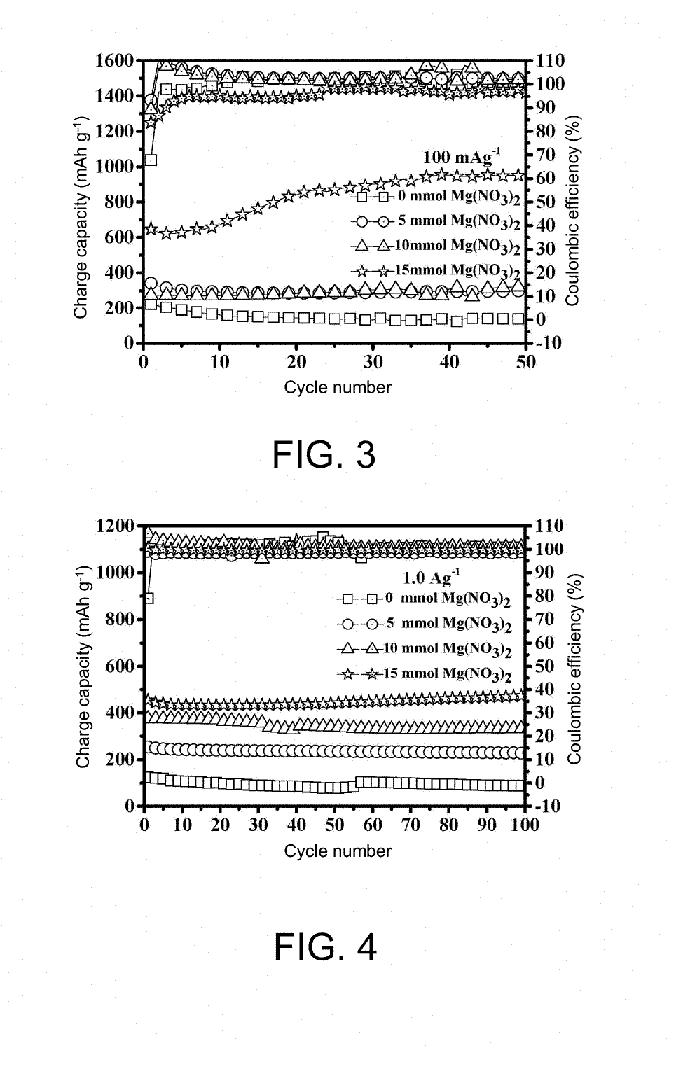

The sodium-ion batteries prepared with the three-dimensional structured cotton fiber carbon materials prepared by using the pore forming agents, magnesium nitrate solutions, having the concentrations of 0 mol/L, 0.25 mol/L, 0.5 mol/L and 0.75 mol/L respectively (that is, the magnesium nitrates have masses of 0 mmol, 5 mmol, 10 mmol and 15 mmol respectively) were subjected to 50-cycle and 100-cycle charge-discharge tests at current densities of 100 mAh/g and 1 A/g respectively. The obtained curves are as illustrated in FIG. 3 and FIG. 4.

As seen from FIG. 3, at the current density of 100 mAh/g, the specific capacities after the initial charge-discharge and the 50-cycle charge-discharge are as listed in Table 1.

Table 1 Specific capacities after the initial charge-discharge and the 50-cycle charge-discharge at the current density of 100 mAh/g.

TABLE 1

| | Concentration of | Concentration of | Concentration of | Concentration |
|---|---|---|---|---|
| | 20 mL | 20 mL | 20 mL | of 20 mL |
| | magnesium | magnesium | magnesium | magnesium |
| | nitrate (amount | nitrate (amount | nitrate (amount | nitrate (amount |
| | of the | of the | of the | of the |
| Capacities | magnesium | magnesium | magnesium | magnesium |
| (mAh/g) | nitrate) | nitrate) | nitrate) | nitrate) |
| 0 mol/L | 0.25 mol/L | 0.5 mol/L | 0.75 mol/L | |
| (0 mmol) | (5 mmol) | (10 mmol) | (15 mmol) | |
| 1^{st} cycle | 222.9 | 341.8 | 274.5 | 647.2 |
| 50^{th} cycle | 137.7 | 299.8 | 322.9 | 956.0 |
| 50-cycle retention | 61.78% | 87.71% | 117.63% | 147.71% |
| rate | | | | |

As seen from FIG. 4, at the current density of 1 A·g⁻¹, the specific capacities after the initial charge-discharge and the 100-cycle charge-discharge are as listed in Table 2.

Table 2 Specific capacities after the initial charge-discharge and the 100-cycle charge-discharge at the current density of 1 A·g⁻¹

TABLE 2

| | Concentration of | Concentration of | Concentration of | Concentration |
|---|---|---|---|---|
| | 20 mL | 20 mL | 20 mL | of 20 mL |
| | magnesium | magnesium | magnesium | magnesium |
| | nitrate (amount | nitrate (amount | nitrate (amount | nitrate (amount |
| | of the | of the | of the | of the |
| Capacities | magnesium | magnesium | magnesium | magnesium |
| (mAh/g) | nitrate) | nitrate) | nitrate) | nitrate) |
| 0 mol/L | 0.25 mol/L | 0.5 mol/L | 0.75 mol/L | |
| (0 mmol) | (5 mmol) | (10 mmol) | (15 mmol) | |
| 1^{st} cycle | 125.0 | 253.9 | 374.5 | 454.4 |
| 100^{th} cycle | 87.2 | 228.0 | 332.7 | 473 |
| 100-cycle | 70.40% | 89.80% | 88.84% | 104.09% |
| retention rate | | | | |

As seen from the above results, the three-dimensional structured cotton fiber carbon materials prepared through pore forming and high temperature carbonization with the addition amounts of magnesium nitrate being 0.25 mol/L, 0.5 mol/L and 0.75 mol/L, when being used as the anode material of the sodium-ion battery, improve the specific capacity of the battery, and exhibit more excellent cycle performance.

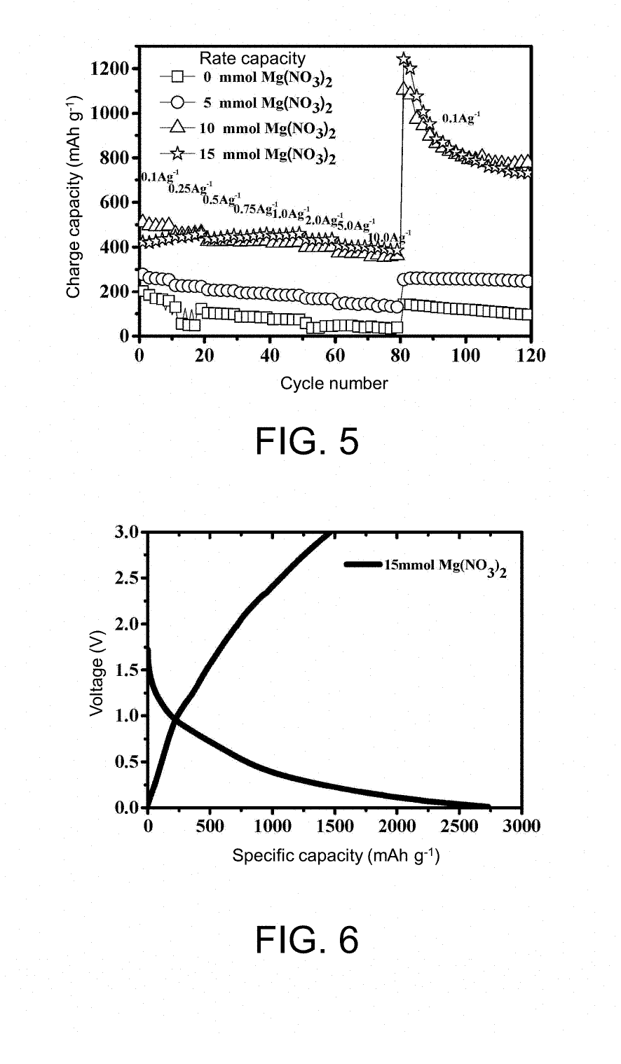

The sodium-ion batteries prepared with the three-dimensional structured cotton fiber carbon materials prepared by using the pore forming agents, the solutions of magnesium nitrate, having the concentrations of 0 mol/L, 0.25 mol/L, 0.5 mol/L and 0.75 mol/L (that is, the magnesium nitrates have masses of 0 mmol, 5 mmol, 10 mmol and 15 mmol respectively), were subjected to charge-discharge tests at current densities with ratings of 100 mA/g, 250 mA/g, 500 mA/g, 1.0 A/g, 2.0 A/g, 5.0 A/g, 10.0 A/g, and 100 mA/g respectively, to test the rate performance of the batteries, as illustrated in FIG. 5. As seen from FIG. 5, when the sodium-ion batteries prepared with the three-dimensional structured cotton fiber carbon materials prepared by using the pore forming agents, the solutions of magnesium nitrate, having the concentrations of 0.5 mol/L and 0.75 mol/L, were subjected to a charge-discharge test at a current density of 100 mA/g after experiencing a great current charge-discharge test, the result indicates that the capacity of the battery is higher than the capacity at the initial current density of 100 mA/g, and more excellent rate performance is exhibited.

(2) Electrochemical Properties of the Prepared Lithium-Ion Batteries

The lithium-ion battery prepared with the three-dimensional structured cotton fiber carbon material prepared through pore forming and high temperature carbonization by using the pore forming agent, the solution of magnesium nitrate, having the concentration of 0.75 mol/L (that is, the magnesium nitrate has a mass of 15 mmol), was subjected to an initial charge-discharge test at a current density of 100 mA/g. The obtained curves are as illustrated in FIG. 6, and an initial coulombic efficiency is 53.47%.

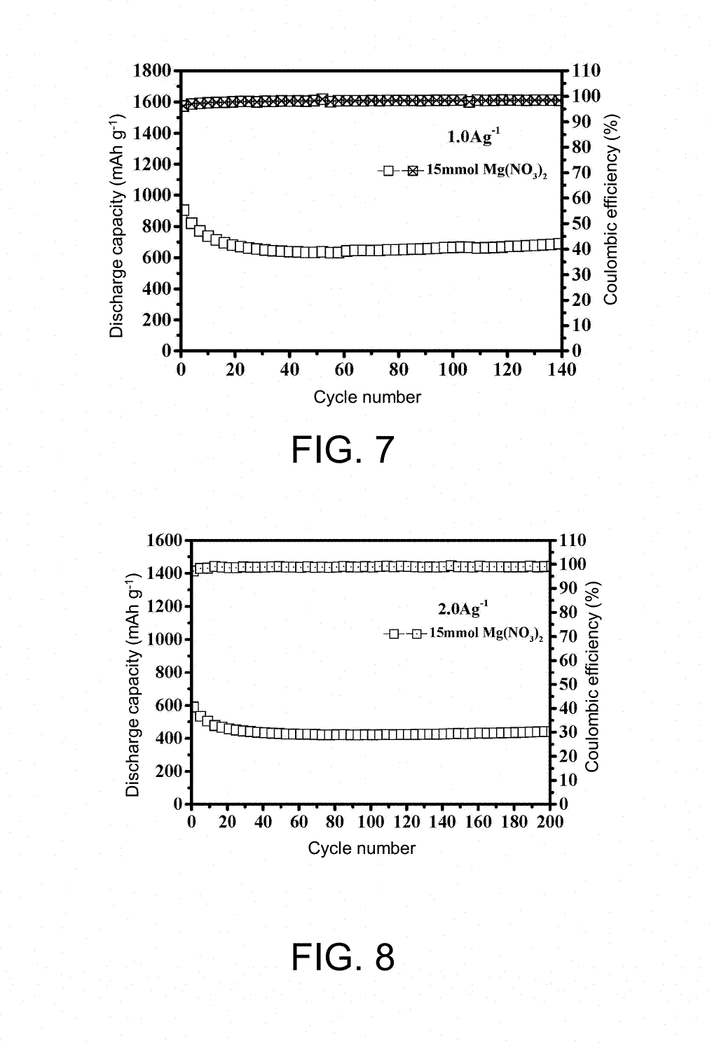

The sodium-ion battery prepared with the three-dimensional structured cotton fiber carbon material prepared by using the pore forming agent, the solution of magnesium nitrate, having the concentration of 0.75 mol/L (that is, the magnesium nitrate has a mass of 15 mmol), was subjected to 140-cycle and 200-cycle charge-discharge tests at current densities with ratings of 1.0 A/g and 2.0 A/g respectively. The obtained curves are as illustrated in FIG. 7 and FIG. 8.

As seen from FIG. 7, the initial discharge specific capacity at the current density of 1.0 A/g is 904.0 mAh/g, and after 140 cycles, the discharge specific capacity is 689.3 mAh/g, and the cycle retention rate is 76.25%.

As seen from FIG. 8, the initial discharge specific capacity at the current density of 2.0 A/g is 590.4 mAh/g, and after 200 cycles, the discharge specific capacity is 439.3 mAh/g, and the cycle retention rate is 74.44%.

As seen from the above results, as compared against the carbon materials that are commonly used for the preparation of lithium batteries, the three-dimensional structured cotton fiber carbon material prepared through pore forming and high temperature carbonization with magnesium nitrate being added, when being used as the anode material of the lithium-ion battery, improves the specific capacity of the battery and exhibits more excellent cycle performance.

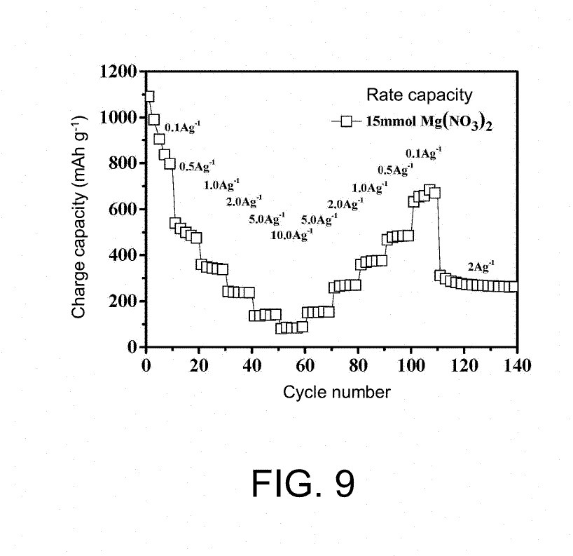

The lithium-ion batteries prepared with the three-dimensional structured cotton fiber carbon material prepared by using the pore forming agent, the solution of magnesium nitrate, having the concentration of 0.75 mol/L (that is, the magnesium nitrate has a mass of 15 mmol), was subjected to charge-discharge tests at current densities with ratings of 100 mA/g, 500 mA/g, 1.0 A/g, 2.0 A/g, 5.0 A/g, and 10.0 A/g respectively, to test the rate performance of the batteries, as illustrated in FIG. 9. As seen from FIG. 9, when the lithium-ion battery was subjected to a charge-discharge test at a current density of 2.0 A/g after experiencing a great current charge-discharge test, the result indicates that the capacity of the battery is higher than the capacity in the initial current density of 2.0 A/g, and more excellent rate performance is exhibited.

### Embodiment 2

Preparation of a Three-Dimensional Structured Bamboo Fiber Carbon Material:

(1) disposable bamboo chopsticks were physically crushed to powder to obtain bamboo fiber powder, 20 mL of a solution of magnesium nitrate having a concentration of 7.5 mol/L was formulated, and 1.5 g of bamboo fiber powder was weighed and sufficiently soaked into the solution of magnesium nitrate;

(2) the bamboo fiber powder was sufficiently wetted and sealed and stored in a 60° C. oven for 24 hours and then taken out, and the bamboo fiber was placed into a 80° C. oven and dried for 12 hours;

(3) the dried bamboo fiber was heated to 900° C. at a heating rate of 5° C./min under an argon atmosphere, and calcinated in a heat preservation manner at 900° C. for 2 hours;

(4) after natural cooling, the bamboo fiber was crushed and ground, and a black powder-like material was obtained; and

(5) the obtained material was washed with a hydrochloric acid having a concentration of 0.5 mol/L and deionized water respectively for three times, then the washed material was placed at a temperature of 80° C. and dried for 24 hours, and finally a dried, black powder-like, three-dimensional structured bamboo fiber carbon material was obtained.

The prepared three-dimensional structured bamboo fiber carbon material is an amorphous material, which, when being used in a sodium-ion battery and a lithium-ion battery, achieves higher charge-discharge capacity and rate performance.

### Embodiment 3

Preparation of a Three-Dimensional Structured Sisal Fiber Carbon Material:

(1) a sisal-made cloth bag was physically crushed to powder to obtain sisal fiber powder, 10 mL of a solution of sodium nitrate having a concentration of 10 mol/L was formulated, and 1.5 g of sisal fiber powder was weighed and sufficiently soaked into the solution of sodium nitrate;

(2) the sisal fiber powder was sufficiently wetted and sealed and stored in a 80° C. oven for 12 hours and then taken out, and the sisal fiber was placed into a 80° C. oven and dried for 12 hours;

(3) the dried sisal fiber was heated to 750° C. at a heating rate of 8° C./min under a mixed atmosphere of argon and 5% hydrogen, and calcinated in a heat preservation manner at 750° C. for 4 hours;

(4) after natural cooling, the sisal fiber was crushed and ground, and a black powder-like material was obtained; and

(5) the obtained material was washed with a hydrochloric acid having a concentration of 3 mol/L and deionized water respectively for three times, then the washed material was placed at a temperature of 100° C. and dried for 6 hours, and finally a dried, black powder-like, three-dimensional structured sisal fiber carbon material was obtained.

The prepared three-dimensional structured sisal fiber carbon material is an amorphous material, which, when being used in a sodium-ion battery and a lithium-ion battery, achieves higher charge-discharge capacity and rate performance.

### Embodiment 4

Preparation of a Three-Dimensional Structured Pineapple Pulp Fiber Carbon Material:

(1) 20 mL of a solution of potassium nitrate having a concentration of 2.5 mol/L was formulated, and 1.5 g of dry pineapple pulp fiber was weighed and sufficiently soaked into the solution of potassium nitrate;

(2) the pineapple pulp fiber was sufficiently wetted and sealed and stored in a 85° C. oven for 15 hours and then taken out, and the pineapple pulp fiber was placed into a 80° C. oven and dried for 12 hours;

(3) the dried pineapple pulp fiber was heated to 600° C. at a heating rate of 8° C./min under a mixed atmosphere of nitrogen and 5% hydrogen, and calcinated in a heat preservation manner at 600° C. for 6 hours;

(4) after natural cooling, the pineapple pulp fiber was crushed and ground to obtain a black powder-like material; and

(5) the obtained material was washed with a hydrochloric acid having a concentration of 3 mol/L and deionized water respectively for three times, then the washed material was placed at a temperature of 80° C. and dried for 12 hours, and finally a dried, black powder-like, three-dimensional structured pineapple pulp fiber carbon material was obtained.

The prepared three-dimensional structured pineapple pulp fiber carbon material is an amorphous material, which, when being used in a sodium-ion battery and a lithium-ion battery, achieves higher charge-discharge capacity and rate performance.

### Embodiment 5

Preparation of a Three-Dimensional Structured Coffee Residue Fiber Carbon Material:

(1) coffee residue was naturally dried and then physically crushed to powder to obtain coffee residue fiber powder, 20 mL of a solution of sodium nitrate having a concentration of 5 mol/L was formulated, and 2 g of coffee residue fiber powder was sufficiently soaked into the solution of sodium nitrate;

(2) the coffee residue fiber was sufficiently wetted and sealed and stored in a 100° C. oven for 4 hours and then taken out, and the coffee residue fiber was placed into a 80° C. oven and dried for 12 hours;

(3) the dried coffee residue fiber was heated to 900° C. at a heating rate of 10° C./min under a mixed atmosphere of argon and 10% hydrogen, and calcinated in a heat preservation manner at 900° C. for 1 hour;

(4) after natural cooling, the coffee residue fiber was crushed and ground to obtain a black powder-like material; and

(5) the obtained material was washed with a hydrochloric acid having a concentration of 1 mol/L and deionized water respectively for three times, then the washed material was placed at a temperature of 80° C. and dried for 24 hours, and finally a dried, black powder-like, three-dimensional structured coffee residue fiber carbon material was obtained.

The prepared three-dimensional structured coffee residue fiber carbon material is an amorphous material, which, when being used in a sodium-ion battery and a lithium-ion battery, achieves higher charge-discharge capacity and rate performance.

1. A three-dimensional structured plant-fiber carbon material for use as an anode material for a sodium-ion battery and a lithium-ion battery, comprising a microstructure, wherein the microstructure is a three-dimensional porous sheet-like structure and a long tunnel structure, a material of the sheet-like structure having a thickness of 5 to 30 nm.

2. A preparation method of the three-dimensional structured plant-fiber carbon material for use as the anode material for the sodium-ion battery and the lithium-ion battery according to claim 1, comprising the following steps:
(1) sealing wetting a plant fiber material into a nitrate solution;
(2) after the sealing wetting, taking out the plant fiber material and drying the material;
(3) calcining the dried plant fiber material in a heat preservation manner under a protective atmosphere;
(4) taking out the carbonized plant fiber material and crushing and grinding the plant fiber material into a powdered plant fiber material; and
(5) sequentially washing with a hydrochloric acid having a concentration of 0.5 to 3 mol/L and deionized water respectively, and drying the powdered plant fiber material to obtain the dried, black powder-like three-dimensional structured plant-fiber carbon material.

3. The preparation method of the three-dimensional structured plant-fiber carbon material for use as the anode material for the sodium-ion battery and the lithium-ion battery according to claim 2, wherein in the step (1), the plant fiber material comprises seed fiber series, bast fiber series, leaf fiber series, fruit fiber series or plant waste fiber series; the seed fiber series comprise cotton fibers or kapok fibers, the bast fiber series comprise flax or bamboo fibers, the leaf fiber series comprise sisal, pineapple fibers or abacas, the fruit fiber series comprise coconut fibers or pineapple pulp fibers, and the plant waste fiber series comprise coffee residues or used disposable bamboo chopsticks.

4. The preparation method of the three-dimensional structured plant-fiber carbon material for use as the anode material for the sodium-ion battery and the lithium-ion battery according to claim 2, wherein in the step (1), a nitrate of the nitrate solution is at least one of magnesium nitrate, sodium nitrate and potassium nitrate, and the nitrate solution has a concentration of 0.1 to 10 mol/L.

5. The preparation method of the three-dimensional structured plant-fiber carbon material for use as the anode material for the sodium-ion battery and the lithium-ion battery according to claim 2, wherein in the step (1), the sealing wetting is carried out at a temperature of 60 to 100° C., and a duration of the sealing wetting is 4 to 24 hours.

6. The preparation method of the three-dimensional structured plant-fiber carbon material for use as the anode material for the sodium-ion battery and the lithium-ion battery according to claim 2, wherein in the step (3), the protective atmosphere is an inert atmosphere, a reduction atmosphere or a mixture atmosphere; the inert atmosphere being nitrogen or argon, the reduction atmosphere being hydrogen, and the mixture atmosphere being a mixture of nitrogen and hydrogen or a mixture of argon and hydrogen, wherein a volume ratio of the hydrogen is 0% to 10%.

7. The preparation method of the three-dimensional structured plant-fiber carbon material for use as the anode material for the sodium-ion battery and the lithium-ion battery according to claim 2, wherein in the step (3), a heating rate of the calcining in the heat preservation manner is 5 to 10° C./min, a temperature of the calcining in the heat preservation manner is 600 to 900° C., and a duration of the calcining in the heat preservation manner is 1 to 6 hours.

8. The preparation method of the three-dimensional structured plant-fiber carbon material for use as the anode material for the sodium-ion battery and the lithium-ion battery according to claim 2, wherein in the step (2) and the step (5), the drying is carried out in an oven at a temperature of 60 to 100° C. for 6 to 24 hours.
